(19) United States
(12) Patent Application Publication
(10) Pub. No.: US 2003/0044014 A1
(43) Pub. Date: Mar. 6, 2003

(54) Method for scrambling a calculation with a secret quantity

(76) Inventors: Pierre-Yvan Liardet, Peynier (FR); Fabrice Romain, Aix En Provence (FR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/236,109

(22) Filed: Sep. 6, 2002

(30) Foreign Application Priority Data
Sep. 6, 2001 (FR) 01/11559

(51) Int. Cl. H04K 1/00

(52) U.S. Cl. 380/268

(57) ABSTRACT

A method for scrambling a calculation involving at least one operation, of which at least one intermediary result takes into account at least one secret quantity, including modifying the intermediary result with a random quantity, carrying on the calculation with the modified result, and restoring an expected result at the end of the calculation.

### BACKGROUND OF THE INVENTION

1. Field of the Invention

The present invention relates to the protection of a secret key or datum (binary word) used in a process of authentication or identification of an electronic circuit (for example, a smart card, an electronic card comprised of one or several integrated circuits) or the like, against piracy attempts. The present invention more specifically relates to the scrambling of calculations taking into account such a secret quantity (also called the secret or private datum or key). “Scrambling” designates a modification of the observable physical features (power consumption, thermal signature, electromagnetic radiation, etc.) induced by the operation of a component.

2. Discussion of the Related Art

An example of application of the present invention relates to a method of countermeasure against an attack by differential power analysis (DPA) of a digital processing circuit exploiting a private or secret datum. Such an attack by power analysis consists of evaluating the statistical dependence between the circuit consumption and the use of digital data processed by a chip and involving a secret value. Indeed, in an algorithmic processing by means of a processing circuit, there exists a dependence between the circuit power consumption and the processed datum. The pirate uses the data input into the circuit and/or provided by it, which thus are “visible” data of an algorithm involving a secret quantity. These data are linked to the algorithm either by being used as direct or indirect operands by it, or by forming a calculation result. The pirate then is able to determine the secret datum present in the circuit, by processing the information provided by the power consumption upon execution of the algorithm and by correlating it with the visible data.

To make attacks by differential power analysis more difficult, a first known solution consists of increasing the complexity of the calculations performed by the circuit. This solution is rapidly limited by the additional calculation power required to execute the algorithm and the calculation time.

A second known solution consists of using a random value to convert the input datum into a scrambled datum taking part in the calculation.

FIG. 1 shows, in the form of a very simplified flowchart, a conventional example of a method for processing a datum A by an algorithm involving a secret datum s in an execution function f. When input, datum A is converted into a datum A′ (block 1) by a using a random value r. This conversion consists, for example, of applying an arithmetical operation to operands A and r. Datum A′ is then submitted to the calculation of the actual function f of the algorithm (block 2). This calculation consists of performing an operation B′=f(A′, s), where s is the secret datum. Most often, function f is a modular function in which the size (number of bits) of the modulo is generally predetermined by the number of bits for which the processing circuit is provided. Secret datum s is generally contained in the chip (for example, permanently stored) and is provided to the algorithm in the calculation operation (block 2). The pirate attempts to find this secret datum by differential power analysis.

Once result B′ has been obtained by the implementation of the calculation algorithm, this result is inversely converted (block 3), to restore a datum B at the circuit output. Random amount r must be stored (block 4, MEM(r)) between steps 1 and 3, to be used again upon the inverse conversion applied to the result of the algorithm. Temporary though it may be, quantity r must be stored all along the algorithm execution (from the introduction of the visible datum to the provision of the visible result).

Without the scrambling of datum A into datum A′, the possible piracy is easier since the pirate exploits the knowledge either of input datum A, or of output datum B. The risk comes from the fact that the pirate has access (directly or indirectly knows) to data which will be combined with a secret datum.

A disadvantage of a conventional scrambling process such as illustrated in FIG. 1 is that it requires an additional non-negligible calculation power with respect to the mere execution of the algorithm. Most often, the conversion of A into A′, then of A′ into B, requires as many resources (memory, calculation time, etc.) as the actual calculation of function f of encryption/decryption of the secret quantity, or causes that the encryption/decryption algorithm must be modified and its performances are badly affected thereby.

A so-called “RSA” asymmetrical algorithm of encryption/decryption of a secret quantity involves a modular exponentiation. This known algorithm implements both a private key and a public key. Such an algorithm is described, for example, in work “Handbook of Applied Cryptography” by Alfred J. Menezes, Paul C. van Oorschot, and Scott A. Vanstone, published by CRC Press in 1997, pages 285-286 which is incorporated herein by reference in its entirety.

FIG. 2 illustrates, in the form of a very simplified flowchart, an example of implementation of a modular exponentiation algorithm applying the so-called Chinese remainder theorem (CRT), known as the Garner or “RSA-CRT” algorithm and described, for example, in the above-mentioned work, page 612.

The first step 10 consists of performing preparatory calculations from the visible input data and a secret datum or quantity here designated as d. The visible data introduced in block 10 are a datum M to be processed and a so-called public quantity e. Block 10 corresponds to a so-called phase of assignment of keys and modular exponents which will be used afterwards in the actual algorithm. Values c=d mod(p−1), f=d mod(q−1), a=q−1 mod p, where p and q are two prime numbers known by the depositary of private or secret quantity d are calculated. The product of numbers p and q corresponds to the modulo n (n=p*q) of the resulting datum provided by the algorithm. The quantity is generally calculated once and for all and stored. The relation linking modulos p and q to the private and secret data is:

E=e*d=1 mod[(p−1)*(q−1)].

The first step (block 11) of the actual algorithm consists of calculating modular exponentiations of modulo p (x1=Mc mod p) and of modulo q (x2=Mf mod q).

The algorithm then consists (block 12) of calculating, from the values obtained in blocks 10 and 11, an output datum B such that:

B=Md mod n.

This calculation decomposes in four operations illustrated by blocks 13 to 16, which successively perform the following operations:

v1=(x1−x2) mod p;

v2=v1*a mod p;

v3=v2*q;

and

v4=v3+x2.

The last step 16 provides result B=v4z.

In an attack by differential power analysis, the execution of last step 16 in which value q enables, once found, going back to secret datum d is generally monitored. Indeed, as soon as the factorization (p*q) of the modulo n, which is known, it is enough to solve above equation E to deduce secret quantity d.

FIG. 3 very schematically shows, in the form of blocks, the essential steps of a so-called DSA dissymmetrical message signature algorithm.

This algorithm receives as an input a datum or a message to be signed M, two values p and q representing prime numbers, a so-called chopping function h( ) and a generator α of the cyclic group of integers modulo p.

In a first phase of the DSA algorithm, a random integer k, between 0 and q, is drawn, and a first result is calculated (block 30):

t=(αk mod p)mod q.

The inverse of random number k modulo q is then calculated (block 31): k−1 mod q.

The preceding steps form a first phase of the algorithm.

After this first phase, another quantity B involving a secret datum d is calculated. This second phase 32 essentially includes three steps. In a first step 33, the so-called chopping function is applied to input datum M (u1=h(M)). In a second step 34, an intermediary quantity u2 taking into account secret datum d is calculated according to formula:

u2=u1+d*t mod q.

In a third and last step 35, a quantity u3 is calculated according to the following relation:

u3=u2*k−1 mod q.

Quantity u3 corresponds to the searched result B. The signature then is pair (t, B). In a DSA-type algorithm, the two components t and B of the signature as well as message M are visible data.

WO-A-01/48706 discloses a method for scrambling a calculation involving a secret quantity applied to an RSA-type algorithm, wherein a random quantity is introduced at the beginning of the calculation, in the modulo. The desired result is restored at the end of the calculation through a modular reduction.

WO-A-98/52319 discloses a method wherein a random quantity is introduced ahead of an RSA-CRT-type algorithm, at the beginning of an operating process.

### SUMMARY OF THE INVENTION

The present invention aims at providing a solution for scrambling a calculation involving a secret quantity which requires less resources than conventional solutions.

The present invention also aims at providing a solution which reduces or minimizes the storage duration of a random quantity used for the scrambling, or even suppresses the memorization of the random quantity.

The present invention further aims at providing a solution particularly intended for the scrambling of algorithms of RSA-CRT or DSA type against an attack by differential power analysis.

To achieve these objects as well as others, the present invention provides a method for scrambling a calculation involving at least one operation, of which at least one intermediary result takes into account at least one secret quantity, and including the steps of:

modifying said intermediary result with a random quantity;

carrying on the calculation with the modified result; and

restoring an expected result at the end of the calculation.

According to an embodiment of the present invention, the intermediary result corresponds to the result of an operation simultaneous or subsequent to the operation during which the secret datum is taken into account.

According to an embodiment of the present invention, the random quantity is not stored.

According to an embodiment of the present invention, said intermediary result has the following form:

v1*a mod p,

where p represents a prime number, where a represents the result of a prior operation involving number p and where v1 represents a number which is a function of the secret quantity.

According to an embodiment of the present invention, a number proportional to said random quantity is added to said intermediary result.

According to an embodiment of the present invention, the factor of the number proportional to the random quantity is the modulo of the expected result, the restoring of the expected result being performed by modular reduction based on said modulo.

According to an embodiment of the present invention, the factor is a unity factor, and the restoring of the expected result is performed by subtracting the product of the random quantity by the quotient, by number p, to the modulo of the expected result.

According to an embodiment of the present invention, said intermediary result has the following form:

u1+d*t mod q,

where q represents a prime number, where t represents the result of a first previous operation involving number q, where u1 represents the result of a second previous operation which is a function of an input datum, and where d represents the secret quantity.

According to an embodiment of the present invention, number q is multiplied by the random quantity.

According to an embodiment of the present invention, the random quantity is added to result u1.

According to an embodiment of the present invention, the random quantity is added to result t.

The foregoing objects, features and advantages of the present invention will be discussed in detail in the following non-limiting description of specific embodiments in connection with the accompanying drawings.

### BRIEF DESCRIPTION OF THE DRAWINGS

FIG. 1, previously described, very schematically shows in the form of blocks, a conventional example of a method for scrambling a calculation implementing a secret quantity;

FIG. 2, previously described, very schematically illustrates in the form of blocks, a conventional algorithm of RSA-CRT type;

FIG. 3, previously described, very schematically illustrates in the form of blocks, a conventional algorithm of DSA type;

FIG. 4 very schematically illustrates the generalized principle of the scrambling method according to the present invention;

FIG. 5 illustrates in a partial block diagram, a first embodiment of the scrambling method according to the present invention, applied to an algorithm of RSA-CRT such as illustrated in FIG. 2;

FIG. 6 illustrates, in a partial block diagram, a second embodiment of the scrambling method according to the present invention, applied to the RSA-CRT algorithm of FIG. 2;

FIG. 7 illustrates, in a partial block diagram, a third embodiment of the scrambling method according to the present invention, applied to the RSA-CRT algorithm of FIG. 2;

FIG. 8 illustrates, in the form of blocks, the first embodiment of the present invention, applied to the DSA algorithm of FIG. 3;

FIG. 9 illustrates, in the form of blocks, the second embodiment of the present invention, applied to the DSA algorithm of FIG. 3; and

FIG. 10 illustrates, in the form of blocks, the third embodiment of the present invention, applied to the DSA algorithm of FIG. 3.

### DETAILED DESCRIPTION

For clarity, only those steps of the method and algorithm which are necessary to he understanding of the present invention have been shown in the drawings and will be described hereafter. In particular, steps involving public quantity, operand, and result exchanges have not been described in detail. Further, the calculation means used, be they hardware or software, as well as the storage and random quantity generation means, are conventional.

FIG. 4 very schematically illustrates in a general manner the scrambling method according to the present invention. Said method generally applies to any algorithm comprised of an operation OP directly involving a secret quantity d with a known quantity M. According to the present invention, a random quantity r is involved in the algorithm and the expected result B is restored at the end of the calculation. A feature of the present invention is that the random quantity intervenes at the soonest in the operation where the secret quantity is taken into account. Preferably, the random quantity intervenes on an intermediary result subsequent to the last operation taking the secret datum into account. Piracy attempts are thus made more difficult by scrambling the calculation on quantities which are not visible, and by reducing or minimizing the possible storage duration of the random quantity.

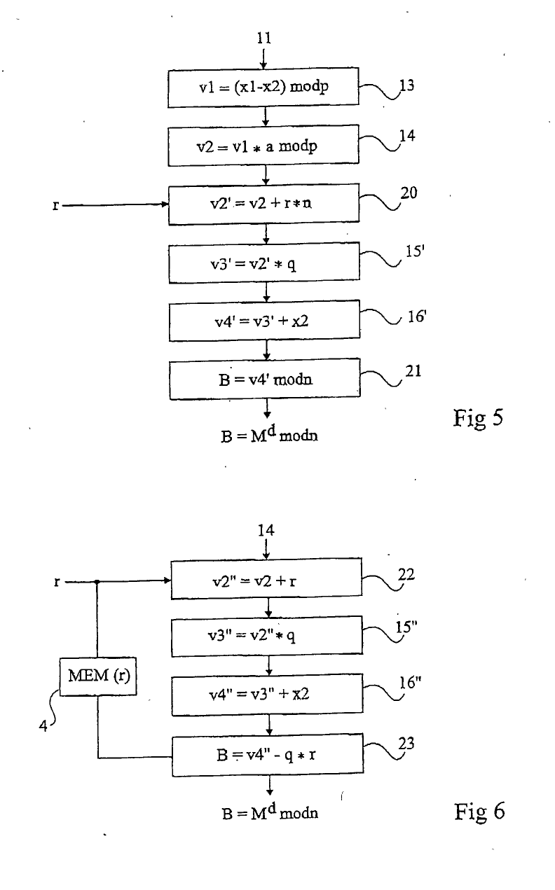

FIG. 5 shows, in the form of blocks, an embodiment of the scrambling method of the present invention applied to an algorithm of RSA-CRT type such as illustrated in FIG. 2. In FIG. 5, only the steps of the actual algorithm, that is, corresponding to steps 13 to 16 of FIG. 2, have been shown. Steps 13 and 14, as well as the preceding steps (not shown), are not modified by the implementation of the present invention.

The first step (block 20) of this embodiment includes scrambling value v2 resulting from step 14 by means of a random quantity r. This step performs the following operation:

v2′=v2+r*n,

where n represents the known modulo of the expected result.

The next steps of the RSA-CRT algorithm are then implemented with no other modification than to be applied to value v2′ instead of value v2. In FIG. 5, these steps are illustrated by blocks 15′ and 16′, step 15′ providing a result v3′ while step 16′ provides a result v4′.

According to the present invention, result v4′ is submitted to a modular reduction modulo n (block 21, v4′ mod n) to obtain result B.

This result respects the conventional formula Md mod n of the RSA-CRT algorithm. Indeed, quantity v4′ may be written as:

v4′=[(v1*a mod p+r*n)*q+x2]mod n.

This amounts to writing:

v4′=[v2*q+r*n*q+x2] mod n, that is:

v4′=(B+r*n*q)mod n.

Now, r*n*q mod n=0 and B already is a value modulo n. Accordingly, v4′=B.

FIG. 6 shows a second embodiment of the scrambling method of the present invention, applied to an algorithm of RSA-CRT type.

As in the first embodiment, the present invention includes scrambling an intermediary calculation datum and the conventional steps are not modified until and including step 14.

According to the second embodiment of FIG. 6, quantity v2 is transformed into a quantity v2″=v2+r (block 22), where r represents a random quantity.

Afterwards, the steps of the RSA-CRT algorithm are not modified. Step 15″ is applied to datum v2″ and provides result v3″, while step 16″ is applied to datum v3″ and provides result v4″.

According to this embodiment of the present invention, result B is obtained by subtracting to result v4″ quantity q*r (block 23). According to this embodiment, random quantity r is stored (block 4, MEM(r)) between steps 22 and 23.

Result B may be written as:

B=v2″*q+x2−q*r, that is:

B=(v1*a mod p+r)*q+x2−q*r.

The above expression can further be written as:

B=v2*q+r*q+x2−q*r, or:

B=v3+x2, which does correspond to:

B=Md mod n (see FIG. 2).

Random value r, for the second embodiment of FIG. 6, has the same size as p. If not, step 22 is performed modulo p, that is, v2″=(v2+r) mod p.

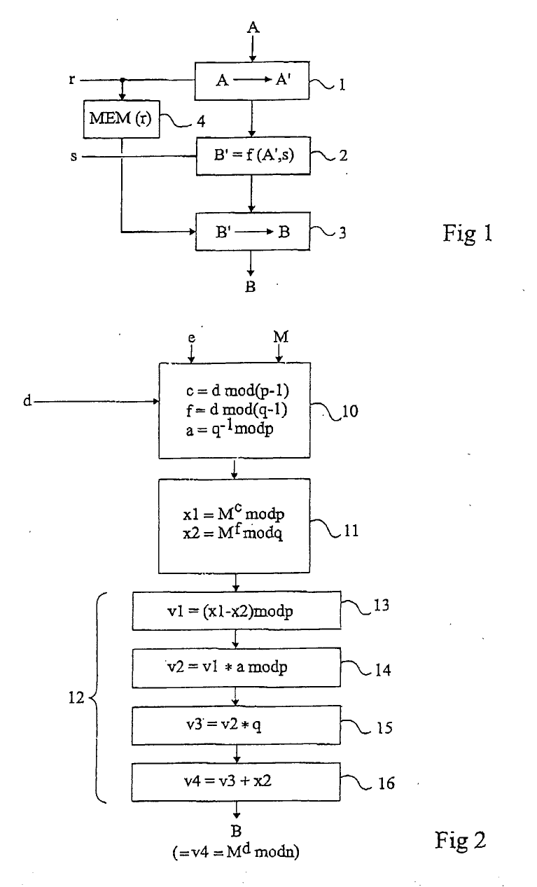

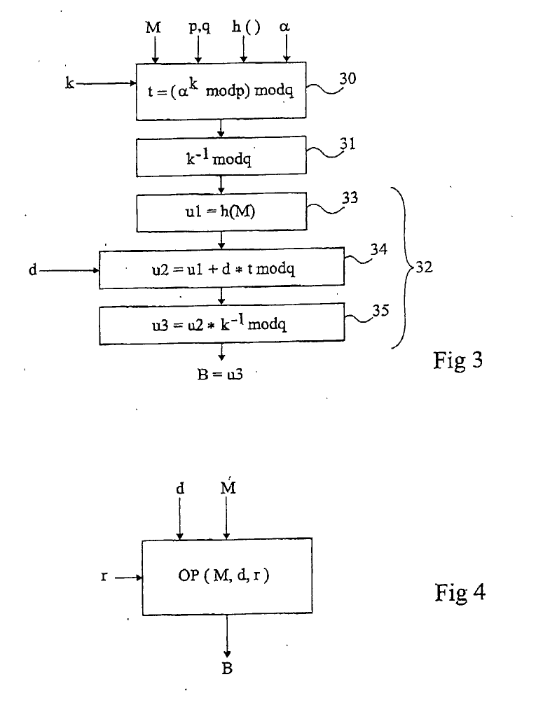

As compared to the embodiment of FIG. 5, that of FIG. 6 requires temporarily storing the random quantity. However, this memorization needs not be maintained from the introduction of the visible input datum to the end of the algorithm. It is thus present in the register or the like used as a storage element for a duration shorter than that of the conventional scrambling method (FIG. 1).

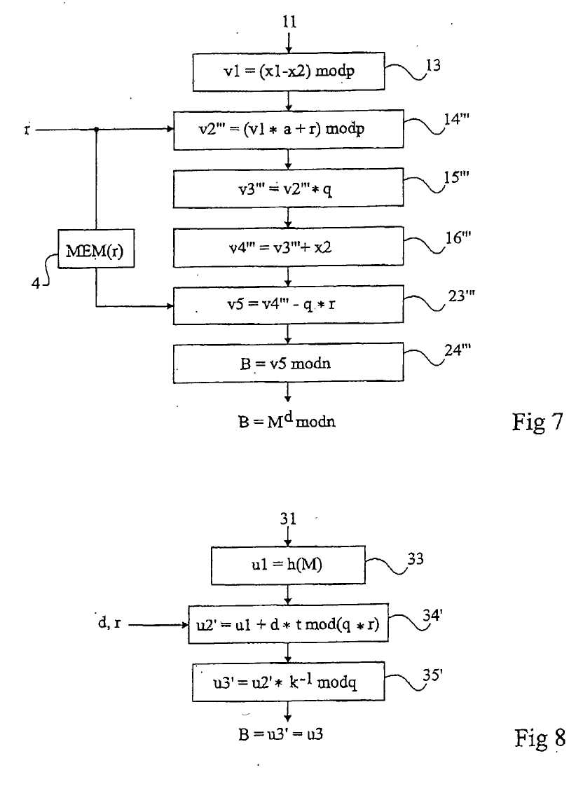

FIG. 7 shows a third embodiment of the scrambling method of the present invention, applied to an algorithm of RSA-CRT type.

As in the other embodiments, the present invention includes scrambling an intermediary calculation datum. The conventional steps are not modified until and including step 13.

According to the third embodiment of FIG. 7, step 14 becomes a step 14′″ in which a random quantity is involved according to the following relation:

v2′″=(v1*a+r)mod p.

As in the second embodiment, random value r has the same size as p.

Step 15′″ is applied to datum v2′″ and provides result v3′″, while step 16′″ is applied to datum v3′″ and provides a result v4′″.

According to this embodiment of the present invention, a step 23′″ similar to step 23 of FIG. 6 is performed, that is, quantity q*r is subtracted to result v4′″. Random quantity r is thus memorized (block 4, MEM(r)) between steps 14′″ and 23′″. Finally, a step 24 similar to step 21 (modular reduction modulo n) of FIG. 5 is applied, but to result v5. B is then obtained.

Indeed, quantity v2′″ can be written as:

v2′″=(v1*a mod p+r)mod p, that is:

v2′″=(v2+r)mod p.

Now, by definition of the modulo, the above relation means that there exists a value w such that:

v2′″+w*p=v2+r, which can be written as:

v2′″=v2+r−w*p.

Replacing this value of v2′″ in the equation of v3′″, than in those of v4′″ and v5 provides:

v5=v2*q+r*q−w*p*q+x2−q*r, that is:

v5=v3+x2−w*n.

The modular reduction of step 24 provides:

B=v4, since:—w*n mod n=0.

FIGS. 8 to 10 illustrate three embodiments of the scrambling method of the present invention applied to a DSA-type algorithm. These drawings only show the steps of the second phase of the DSA algorithm, the first phase being unmodified by the implementation of the present invention.

According to the first embodiment illustrated in FIG. 8, step 33 is not modified. The implementation of the present invention includes applying (block 34′) to quantity d*t of the next step, a modulo q*r, where r represents a random quantity: u2′=u1+d*t mod(q*r).

The next step (block 35′) uses the conventional calculation, but applied to quantity u2′, u3′=u2′*k−1 mod q. Step 35′ provides result B which corresponds to the same result u3 as that obtained in a conventional method.

Indeed, u3′ can be written as:

u3′=u2′*k−1 mod q, that is:

u3′=[u1+d*t mod(q*r)]*k−1 mod q.

Now, whatever value y:

[y mod(q*r)]mod q=y mod q.

Accordingly:

u3′=u2*k−1 mod q.

In the embodiment of FIG. 8, the same characteristic as in the embodiment of FIG. 5 is used, that is, that it is not necessary to store quantity r.

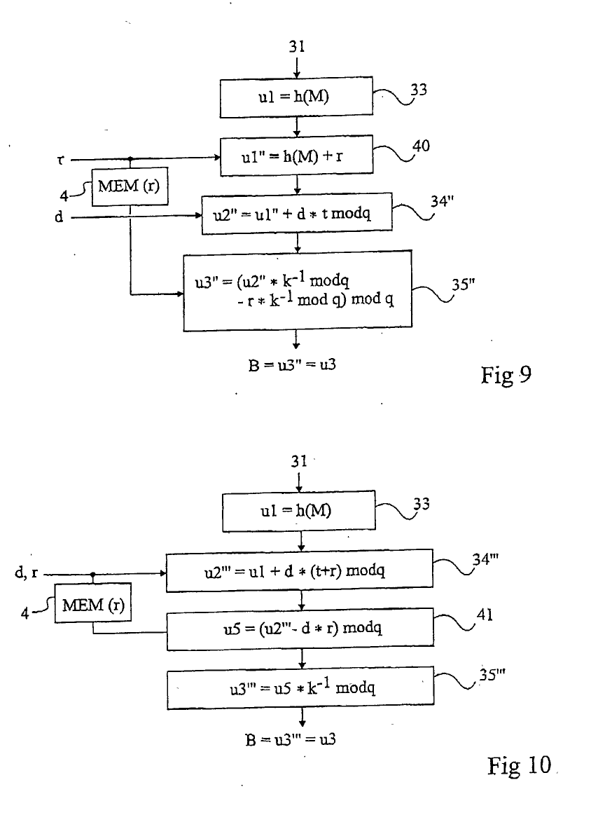

According to the second embodiment illustrated in FIG. 9, step 33 of application of the chopping function is not modified. A random quantity r is added (block 40) to result u1 of this function to obtain a result u1″. The next step of the DSA algorithm is then applied to intermediary result u1″. This amounts to performing a step 34″ of calculation of u2″:

u2″=u1″+d*t mod q.

To calculate u2″, it will be ascertained to mask product d*t mod q. It is enough to start with quantity u1″.

The next step of the algorithm is not modified, but is implemented on quantity u2″ (block 35″):

u3″=[u2″*k−1 mod q−r*k−1 mod q]mod q.

Step 35″ provides result B which corresponds to the same result as that obtained by the implementation of the conventional DSA algorithm.

Indeed, one may write:

u3″=[(h(M)+r+d*t mod q)*k−1 mod q−r*k−1 mod q]mod q, that is:

u3″=[h(M)+d*t mod q]*k−1 mod q=u3.

As in the embodiment of FIG. 6, it is here necessary to temporarily store random quantity r between steps 40 and 35″.

According to the third embodiment illustrated in FIG. 10, step 33 of application of the chopping function is not modified. At the next step 34′″, random quantity r is introduced by being added to factor t. This amounts to performing the following calculation:

u2′″=u1+d*(t+r)mod q.

Then, according to this embodiment, an additional step 41 in which random quantity r and the secret datum are used again is introduced. This step includes calculating a quantity u5 from the following relation:

u5=(u2′″−d*r)mod q.

Then, the normal algorithm is resumed by applying step 35′″ to quantity u5. This amounts to calculating:

u3′″=u5*k−1 mod q.

Step 35′″ provides result B, which corresponds to the same result as that obtained by implementing the conventional DSA algorithm.

Indeed, one may write:

u3′″={[h(M)+d*(t+r)mod q−d*r]mod q}*k−1 mod q, that is:

u3′″={[h(M)+d*t mod q+d*r mod q−d*r]mod q}*k−1 mod q, or else:

u3′″=[h(M)+d*t mod q]*k−1 mod q, and thus

u3′″=u3.

An advantage of the present invention is that the scrambling by means of a random quantity is not performed on the input datum (which is visible) but on an intermediary datum of the calculation.

An advantage of the embodiments of FIGS. 5 and 8 is that random value r needs not be stored. Accordingly, the attack by differential power analysis is almost impossible, the calculation being scrambled by a random value which is not known by the attacker. Indeed, the fact of involving a different random quantity for each processing makes piracy almost impossible. Quantity r must for this purpose remain secret and is thus preferentially ephemeral.

Another advantage of the present invention, whatever the embodiment, is that the necessary resources are negligible with respect to the rest of the algorithm implementation. Indeed, only operations requiring small resources are introduced (additions, subtractions, multiplications, reductions, etc.) while the diagram of FIG. 1 requires a modular inversion of a random quantity, which is a much more resource-consuming operation.

Of course, the present invention is likely to have various alterations, modifications, and improvements which will readily occur to those skilled in the art. In particular, although the present invention has been described in two examples of application to algorithms of DSA type and of RSA-CRT type, it more generally applies to any algorithm implementing similar operations. Further, the choice of one of the embodiments of the present invention is within the abilities of those skilled in the art based on the application, for example, according to the possibility that they have or not to provide a storage of the random quantity and to the desired security level.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for scrambling a calculation involving at least one operation, of which at least one intermediary result takes into account at least one secret quantity, and including the steps of:
modifying said intermediary result with a random quantity;
carrying on the calculation with the modified result; and
restoring an expected result at an end of the calculation.

2. The method of claim 1, wherein the intermediary result corresponds to the result of an operation simultaneous or subsequent to the operation during which the secret datum is taken into account.

3. The method of claim 1, wherein the random quantity is not stored.

4. The method of claim 1, wherein said intermediary result (v2) has the following form:
v1*a mod p,
where p represents a prime number, where a represents the result of a prior operation involving number p and where v1 represents a number which is a function of the secret quantity.

5. The method of claim 4, including adding a number proportional to said random quantity to said intermediary result.

6. The method of claim 5, wherein the factor of the number proportional to the random quantity is the modulo of the expected result, the restoring of the expected result being performed by modular reduction based on said modulo.

7. The method of claim 5, wherein the factor is a unity factor, and the restoring of the expected result is performed by subtracting a product of the random quantity by a quotient, by number p, to the modulo of the expected result.

8. The method of claim 1, wherein said intermediary result has the following form:
u1+d*t mod q,
where q represents a prime number, where t represents a result of a first previous operation involving number q, where u1 represents a result of a second previous operation which is a function of an input datum, and where d represents the secret quantity.

9. The method of claim 8, including multiplying number q by the random quantity.

10. The method of claim 8, including adding the random quantity to result u1.

11. The method of claim 8, including adding the random quantity to result t.
